(19) United States
(12) Patent Application Publication
(10) Pub. No.: US 2009/0193409 A1
(43) Pub. Date: Jul. 30, 2009

(54) Per User Updates

(75) Inventors: Lokesh M. Dave, Sammamish, WA (US); Peter A. Williams, Woodinville, WA (US); Vibha Rathi, Redmond, WA (US); Daniel J. Kappes, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/019,622

(22) Filed: Jan. 24, 2008

(51) Int. Cl. G06F 9/44

(52) U.S. Cl. 717/173

(57) ABSTRACT

An update system may receive and apply updates to a client device on a per user basis, where an update may be applied to one user but not another. The user specific updates may make changes to user specific areas of the client device, such as user registries or areas of a file system that may be specific to a the user receiving an update. A download agent may communicate with an update distribution server to receive a description of available updates and may download those updates applicable to individual users. An installing agent may process the updates for each user individually when the user is logged on, and in some cases, when the user is not logged on.

### BACKGROUND

Many software manufacturers issue periodic updates to their software. In some cases, updates may be used to reflect changes for security issues, correct bugs or other problems with the software, and in some cases new features may be added to the software. In many cases, an update package may be downloaded from a server and installed using an installation agent on a client device.

### SUMMARY

An update system may receive and apply updates to a client device on a per user basis, where an update may be applied to one user but not another. The user specific updates may make changes to user specific areas of the client device, such as user registries or areas of a file system that may be specific to a user receiving an update. A download agent may communicate with an update distribution server to receive a description of available updates and may download those updates applicable to individual users. An installing agent may process the updates for each user individually when the user is logged on, and in some cases, when the user is not logged on.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system with per-user updates.

FIG. 2 is a timeline illustration of an embodiment showing a sequence for updating a client.

FIG. 3 is a flowchart illustration of an embodiment showing a method for selecting updates from a set of update package descriptors.

FIG. 4 is a flowchart illustration of an embodiment showing a method for installing an update package.

### DETAILED DESCRIPTION

Updates may be downloaded and installed to a client device within the context of individual users. In many cases, an application or service may be licensed to an individual user, and updates for the application or service may be applied to the user specific areas of a files system, to a user registry, or in any other manner where the update may be applied to a specific user. Applications or services that are operated on a per user basis may enable one user of a device to have access to the application or service while another user of the same device may not have access.

A system for distributing and applying user specific updates may have a rules server that may periodically transmit a set of rules or descriptors that describe various updates that are available for download. A client may process the rules to determine one or more updates to download. An update distribution server may provide an update package for each update selected. The client may then apply the update package for one or more individual users.

In some embodiments, an update package may be downloaded and stored but not applied for a user until the user logs on to the client. Some updates may be applied when the user is logged off in some instances.

The user context in which an update may be installed may comprise user specific registries, user specific portions of a file system, or other user specific components within a computer system.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

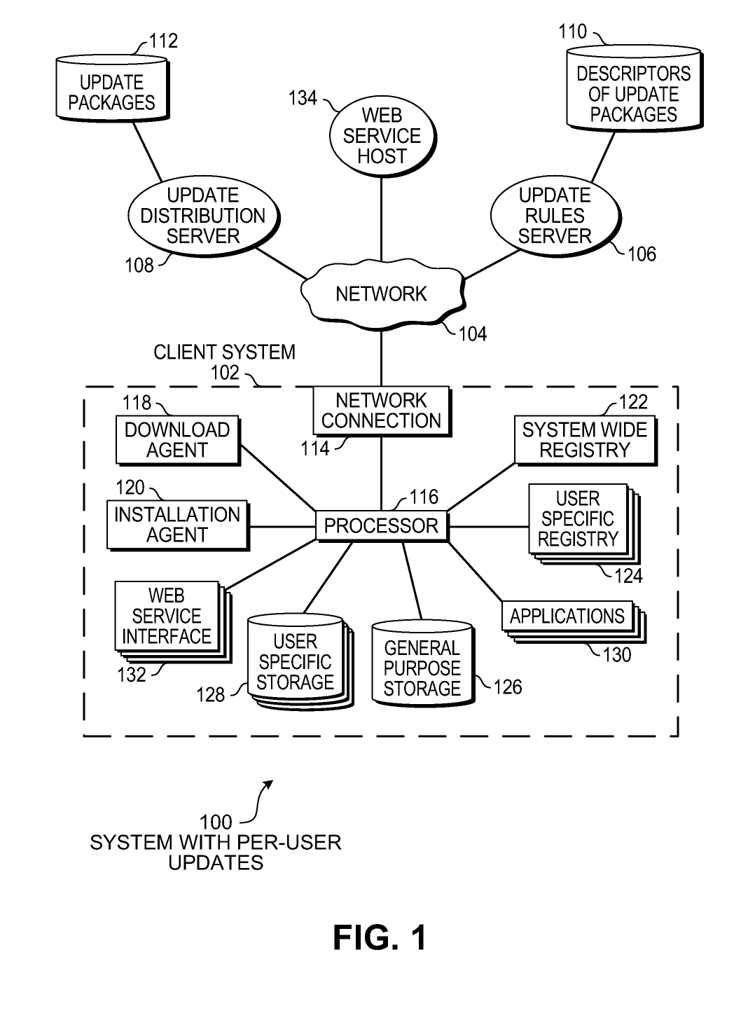

FIG. 1 is a diagram of an embodiment 100 showing a system with per-user updates. Embodiment 100 is an example of a system that may manage and install updates to a client system within a user specific context.

The diagram of FIG. 1 illustrates functional components of a system. The components are illustrated as functional components and may not correspond to a specific hardware, software, or other component. The illustrated components were selected to highlight and describe various functional aspects of a system. Different embodiments may use various hardware and software architectures to achieve similar functions.

In some cases, the component may be a hardware component, a software component, or a combination of hardware and software. Some of the components may be application level software, while other components may be operating system level components, hardware devices, or other elements. Some components may be composed of hardware, software, firmware, and other elements. In some cases, the connection of one component to another may be a close connection where two or more components are operating on a single hardware platform. In other cases, the connections may be made over network connections spanning long distances.

Embodiment 100 is an example of a client system 102 that may install updates on a per user basis for various applications and remote services. The client system 102 may periodically receive update packages that may be installed within a user context on the client system 102. The update packages may be executable code that performs various changes, or may be data, scripts, or executable code that may be operated in conjunction with various installation mechanisms.

Update packages may be installed within a user's context, which may include any registry, file structure, configuration files, or other user specific portion of the client system 102. In many cases, individual users of the client device 102 may subscribe to various web services or purchase and install applications. The web services or applications may be licensed for a single user of the client system 102 and may not be licensed for every user of the client system 102.

Some embodiments may perform the installation of the user specific updates when the user is logged onto the client system 102. Such embodiments may spawn a process or thread under a user's username in order to gain access to files, folders, registries, or other information that is accessible through the user's username. In some cases, such information may not be accessible through processes operated under other usernames.

Other embodiments may perform the installation of the user specific updates when the user is not logged onto the client system 102. Such embodiments may be capable of performing the update modifications through an administrative or general access to various files or information. In some embodiments, a portion of an update package may be installed prior to a user logging on and a second portion may be installed after the user is logged on.

In the embodiment 100, the client system 102 may be connected to a network 104 through which a connection may be made to an update rules server 106 and to an update distribution server 108. In some embodiments, a single server may perform the functions of both the update rules server 106 and the update distribution server 108.

The update rules server 106 may transmit descriptors of update packages 110 from time to time to the client system 102. The descriptors of update packages 110 may have descriptors of several update packages that may be available for download. After selecting a package to download, the client system 102 may establish contact with the update distribution server 108 to request and download a specific update package 112.

In some embodiments, a client system 102 may establish a subscription with the update rules server 106 for periodic sets of descriptors for update packages. The sets of descriptors may be sent to the client system 102 on a periodic basis automatically. In some cases, a user or automated service on the client system 102 may request the descriptors for update packages 110.

The client system 102 may receive the set of descriptors and evaluate the descriptors to determine which update packages, if any, may be applicable to the specific user configurations on the client system 102. The set of descriptors may be any type of definition of available update packages. In some embodiments, the set of descriptors may be in the form of a set of rules that may be evaluated by the client system 102 to determine if an update package may apply.

The client system 102 may receive update packages using many mechanisms. In some embodiments, a client system 102 may subscribe to a service that transmits update packages when the packages are available or on a predefined schedule. In some cases, the update packages may arrive via email or other messaging system and the user may launch the update package after opening the email. In other cases, an automated service may download and install any available package on a periodic basis.

The client system 102 may have a network connection 114 through which a processor 116 may communicate with various devices connected to the network 104, such as the update rules server 106 and the update distribution server 108.

A download agent 118 may operate to communicate with the update rules server 106 and update distribution server 108 to identify and receive update packages that may be installed. The download agent 118 may determine which update packages may be applicable to any of the users of the client system 102 and download those packages to a general purpose storage 126 or some other place.

In many embodiments, the download agent 118 may operate as a background service that may be operational while the client system 102 is operating, regardless of the users who are logged on. In such embodiments, the download agent 118 may be capable of comparing each user's configuration to the set of descriptors of update packages and download and store update packages for later installation.

The download agent 118 may determine a user configuration in many different manners. In some embodiments, each application or service for which updates may be desired may register with the download agent 118. The download agent 118 may store the configuration of each user to use in determining which update packages to download.

In other embodiments, the download agent 118 may analyze various user context areas to determine if an update package may apply. For example, the download agent 118 may search a system wide registry 122 as well as various user specific registries 124, general purpose storage 126, user specific storage, any installed applications 130, web service interface 132, or any other item to determine if an update package may be applicable.

An installation agent 120 may install an update package for a specific user. In some embodiments, the installation agent 120 may read an update package from a general purpose storage 126 and execute the update package. An update package may be used to change many different items on the client system 102, including the system wide registry 122 as well as various user specific registries 124, general purpose storage 126, user specific storage, any installed applications 130, web service interface 132, or any other item.

An update package may have any type of update information and may use any method for conveying the update information to the client system 102. In many cases, an update package may include patches to executable code or operating system functions. In some embodiments, changes may be made to the client system 102 that may be implemented after the client system 102 is restarted. In other cases, an update package may include changes to data files, changes to configuration files, additional or new executable assemblies and dynamic linked libraries, or other change that may be performed directly on a general purpose storage 126 or user specific storage 128. In other cases, an update package may be used to change the system wide registry 122 as well as user specific registries 124.

In some cases, the installation agent 120 may apply one update package to two or more user specific configurations.

The installation agent 120 may perform some or all installation operations for a user while the user is logged off of the client system 102. In other cases, the installation agent 120 may perform some or all installation operations when the user is logged on.

User specific or per-user updates may be applicable to applications or services that are licensed or provided to individual users. For example, a user may download and install one application for managing audio files on the client system 102, while a second user may install a second application for managing audio files on the same client system 102. The first user may have various settings in the user specific registry 124 for the first application, while the second user may have similar settings in the user specific registry 124 for the second application. In both cases, the user may set their specific application as the default application for managing audio files.

Continuing with the example, an update may be received for the first audio management application. An installation agent 120 may install the update for the first user by modifying the user specific registry 124 and user specific storage 128, and such an update may not affect the second user or the second application used by the user.

In some cases, each user may subscribe to a user specific application but an update package may be applied for one user but not another. For example, an update package may be received and stored in the general purpose storage 126. An installation agent 120 may be started when a first user logs onto the client system 102. The installation agent 120 may offer an option to the first user to install or ignore the update package. The first user may elect to install the update package. A second user may log onto the client system 102, be presented with the option to install the same update package, and may decline. In such a case, the first user may operate an application with the update installed and the second user may operate the same application without the update.

The update system may be applied to various applications 130 as well as web services. A web service or other remote service may have an interface 132 that may operate on the client system 102 and communicate with a web service host 134 that may be reached through the network 104. The interface 132 may be a thin client, a web browser, thick client, or any other application or executing code on the client system 102 that may communicate with the web service host 134. In many embodiments, a web service may be made available on a per-user basis. As such, updates that may be applied to the web service interface 132 may be applied on a per-user basis as well.

The client system 102 may be any type of device that may host an application, function, or service that may be updated. In some embodiments, the client system 102 may be a general purpose device such as a desktop computer, laptop computer, server, or some other general purpose computing device. In other embodiments, the client system 102 may be a handheld device such as a personal digital assistant, mobile phone, or other such device.

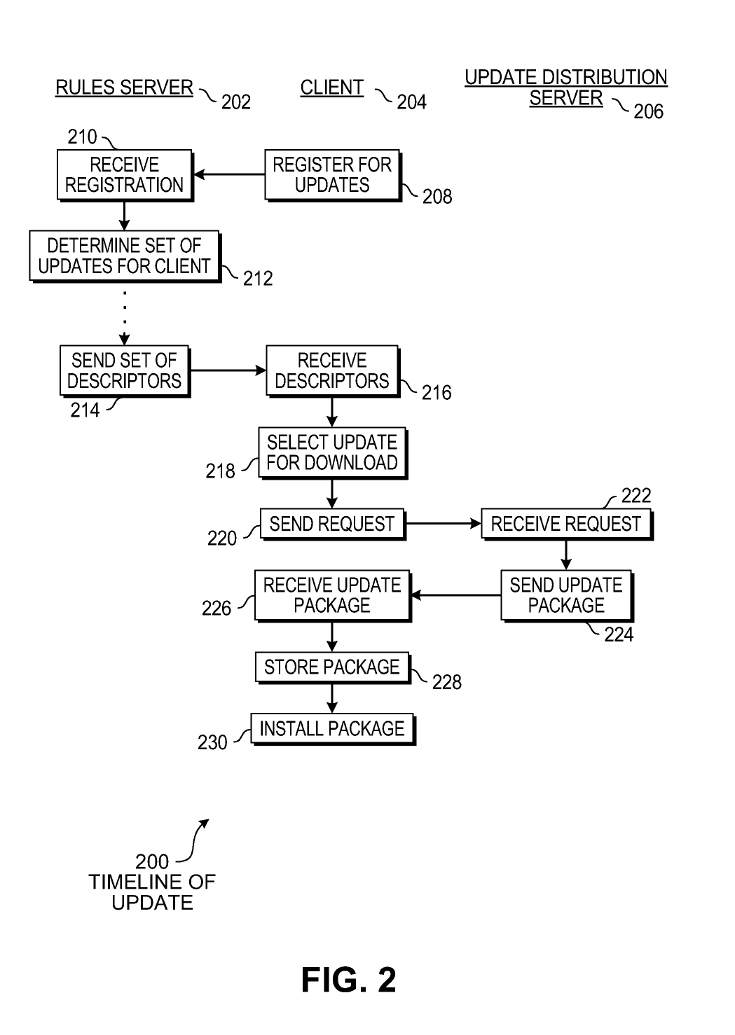

FIG. 2 is a timeline illustration of an embodiment 200 showing a timeline of an update. Embodiment 200 is merely one example of a sequence of interactions that may take place between a rules server 202, a client 204, and an update distribution server 206. Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 200 illustrates the operations of a rules server 202 in a column on the left, the operations of a client 204 in a column in the center, and the operations of an update distribution server 206 on the right.

The rules server 202 may provide various descriptions of updates that may be available to the client 204 and the update distribution server 206 may provide the update packages to the client 204. The client 204 may receive and install the update packages on a per-user basis.

The client 204 may register for updates in block 208 with the rules server 202. The rules server 202 may receive the registration in block 210. In some cases, a rules server 202 may be capable of providing update descriptors for many different applications, operating systems, web services, or other updatable components. During the registration process, a client 204 may provide a description of the applications or services to associate with the client 204. In some cases, the client 204 may provide a description of hardware, software, and services associated with the client 204 and the rules server 202 may determine a set of updates for the particular client in block 212.

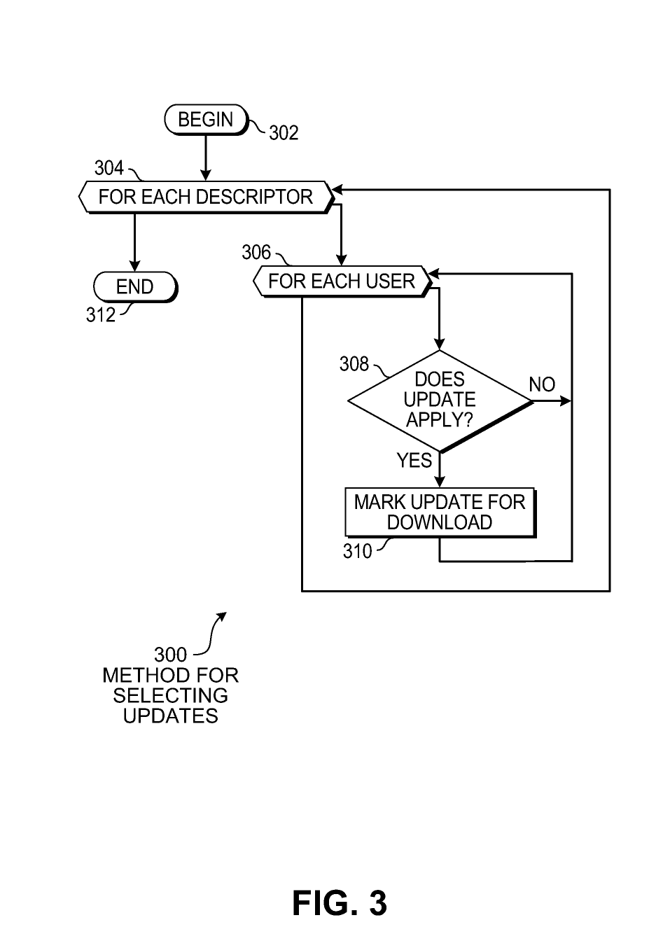

The rules server 202 may send a set of update descriptors in block 214, which may be received by the client 204 in block 216. The client 204 may select one or more updates to download in block 218. One method for determining which updates to download is illustrated in FIG. 3 in this specification.

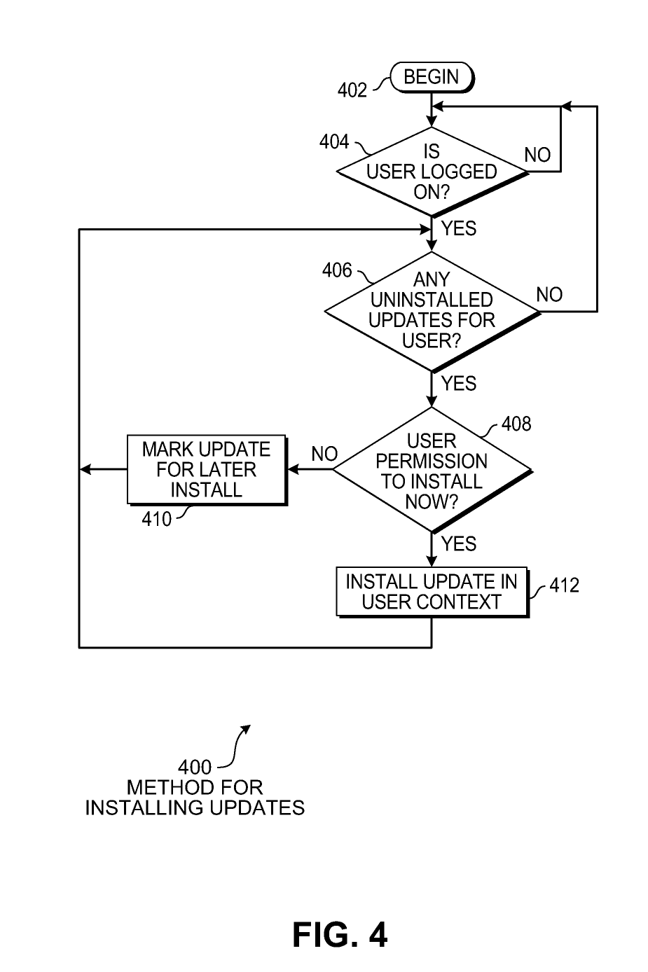

A request for an update package may be sent in block 220 by the client 204 and received in block 222 by the update distribution server 206. The update distribution server 206 may send the update package in block 224 which may be received in block 226 by the client 204. The package may be stored in block 228 and installed in block 230. An example of an embodiment that may be used for installing an update package may be found in FIG. 4 of this specification.

Embodiment 200 illustrates one mechanism by which a client may receive and install periodic updates. In some embodiments, the client 204 may have various processes or background applications that may periodically communicate with the rules server 202 and update distribution server 206 to select and download update packages.

In some embodiments, a user on the client 204 may initiate a download of a set of update package descriptors. In some cases, a user on the client 204 may manually select update packages for download and may also cause the download to be performed. Other embodiments may have some or no user interaction during various portions of the process.

FIG. 3 is a flowchart illustration of an embodiment 300 showing a method for selecting updates. Embodiment 300 is merely one example of a sequence that may be used to select specific updates from a set of update package descriptors. Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 is a method that may be used to select updates from a set of update package descriptors. In many cases, the update package descriptors may be a set of rules or other information that may be used to determine if an update package may be used on a client device. Embodiment 300 is an example of a process that may be used by a client device to analyze the descriptors for each user.

The process may begin in block 302.

For each descriptor in a set of descriptors in block 304, an analysis may be performed for each user in block 306.

For each user in block 306, if an update applies in block 308, the update may be marked for download in block 310. If the update does not apply in block 308 for a particular user, the next user is evaluated in block 306.

The determination in block 308 may be an analysis that evaluates an update description against a predefined list of user applications, functions, or services that may be updated. In some cases, the determination in block 308 may be performed by analyzing various user specific registries, user specific storage areas, or other user specific items to determine if an update may be applicable.

Other embodiments may use different techniques or methods to determine if an update package may be applicable for a specific user on a client device.

FIG. 4 is a flowchart illustration for an embodiment 400 illustrating a method for installing updates. Embodiment 400 is merely one example of a sequence for performing an installation. Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 400 is an example of a logic sequence that may be applied for the installation of a user specific update. Other embodiments may use different logic and may have more or less automated or manual decision points. Embodiment 400 is an example of an installation process that may be performed when a user is logged on and when the user gives permission for the update to be performed.

In other embodiments, an automated service may perform an update without user interaction. Some embodiments may also be capable of installing a user specific update when the user is logged off.

In many cases, a user may log on to a client device prior to installing an update package so that the user's context may be established. The user's context may include installation processes operating with the user's username, which may give those processes access to files, folders, and other resources for which permission may be denied to processes with other usernames. The user's context may also include user specific registries or other user specific items.

The process may begin in block 402.

If the user is not logged on in block 404, the process loops until a user is logged on. When the user is logged on in block 404, if no uninstalled updates exist in block 406, the process loops back to block 404.

If uninstalled updates exist in block 406, user permission may be requested in block 408 to proceed with installation. In some embodiments, user permission may be obtained through an input device on a graphical user interface. In other embodiments, user permission may be given once and stored for future update packages.

If user does not grant permission in block 408, the update may be marked for later installation in block 410. When permission is granted in block 408, the update package may be installed within the user context in block 412.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A system comprising:
a first connection to an update distribution server;
a download agent configured to receive a first update package from said update distribution server; and
an installation agent configured to:
determine that said first update package is applicable to a first user; and
install said update package within a context for said first user.

2. The system of claim 1 further comprising:
a second connection to an update rules server;
said download agent being further configured to:
download a set of update descriptors from said update rules server;
determine that a first descriptor is applicable to said first user, said first descriptor being a descriptor for said first update package.

3. The system of claim 2, said first descriptor comprising a link to said update distribution server.

4. The system of claim 1 further comprising:
a local store capable of storing said first update package.

5. The system of claim 1, said installing agent being further configured to:
determine that said update package is not applicable to a second user.

6. The system of claim 1, said installing agent being configured to modify a user specific registry using said update package.

7. The system of claim 1, said installing agent being configured to modify a user specific portion of a file system using said update package.

8. The system of claim 1, said installing agent being configured to install said first update package when said first user is logged on.

9. The system of claim 1, said installing agent being configured to install said first update package when said user is not logged on.

10. A method comprising:
contacting an update distribution server;
receiving a first update package from said update distribution server;
determining that said first update package is to be applied with respect to a first user;
applying said first update package within said first user's context.

11. The method of claim 10 further comprising:
receiving a set of descriptors comprising descriptors for a plurality of update packages from an update rules server; and
determining that a first descriptor applies to said first user, said first descriptor comprising a description of said first update package.

12. The method of claim 11 further comprising:
determining a link to said update distribution server from said first descriptor; and
contacting said update distribution server using said link.

13. The method of claim 10 further comprising:
receiving a second update package from said update distribution server;
determining that said second update applies to a second user; and
applying said second update package within said second user's context.

14. The method of claim 10 further comprising:
storing said first update package in a local store.

15. The method of claim 10 further comprising:
determining that said first update package is to be applied with respect to a second user; and
applying said first update package within said second user's context.

16. The method of claim 10, said first update package comprising changes to a user specific registry.

17. The method of claim 10, said first update package comprising changes to a user specific portion of a file system.

18. The method of claim 10, said applying being performed when said first user is logged on.

19. The method of claim 10, said applying being performed when said first user is not logged on.

20. A computer readable medium comprising computer executable instructions configured to perform the method of claim 10.
